(19) United States
(12) Patent Application Publication
(10) Pub. No.: US 2026/0210843 A1
(43) Pub. Date: Jul. 23, 2026

(54) TEST DEVICE

(71) Applicant: Axagarius GmbH & Co. KG, Düren (DE)

(72) Inventors: Ralph HUSMANN, Düren (DE); Jürgen Hoffmann, Düren (DE)

(21) Appl. No.: 19/443,700

(22) Filed: Jan. 8, 2026

(30) Foreign Application Priority Data
Jan. 20, 2025 (DE) 202025100270.1

(51) Int. Cl. G01N 21/29

(52) U.S. Cl. CPC G01N 21/29

(57) ABSTRACT

A test device comprises a test unit with a substrate and at least one test field provided on the surface of the substrate and further comprises at least one reagent, wherein at least one additional protective agent field is provided on the surface of the substrate, which has a desiccant and/or an oxygen absorber.

### CROSS-REFERENCE TO RELATED APPLICATIONS AND CLAIM TO PRIORITY

This application is related to utility model no. 20 2025 100 270.1, filed in Germany on Jan. 20, 2025, the enter disclosure of which is incorporated herein and to which priority is claimed.

### FIELD OF THE INVENTION

The present invention relates to a test device comprising a test unit with a substrate and at least one test field provided on the surface of the substrate and comprising at least one reagent.

### BACKGROUND OF THE INVENTION

Test devices of this type are particularly well known as test strips and have been an important component in the field of rapid testing for decades. They allow rapid, simple, and semi-quantitative determination of various parameters with unknown concentrations in liquids. The analyte reacts with an indicator or reagent on a test field of the test strip and causes a color reaction or color change. The reaction color can be evaluated using a color scale. The higher the concentration of the analyte in the tested liquid, the stronger the color reaction.

For ease of use, reactive test papers are applied as test fields on the strip-shaped substrate. This prevents contact with the test solution by the user. The test papers can be applied to the substrate using hot glue or double-sided adhesive tape, for example. Multiple test fields on the substrate allow simultaneous analysis of different parameters.

Test strips are used, among other things, in urine analysis and in the analysis of swimming pool, aquarium, and surface water. In addition, they are used to analyze drinking and cooking water as well as process and wastewater.

Usually, several test strips are packaged in aluminum or plastic containers and the containers are sealed with a stopper. To protect against moisture, a desiccant, such as a molecular sieve or silica gel, is placed in the stopper. It is also possible to provide a bag of desiccant in the container. The desiccant protects moisture-sensitive test fields such as nitrate, nitrite, peroxide, etc. from moisture and thus rapid aging. In this way, increased shelf lives of currently one year or more are achieved.

Alternatively, test strips are sealed individually, i.e., shrink-wrapped in aluminum or paper foil. These test strips are usually packaged without desiccant. This results in a shorter shelf life compared to test strips that are packaged in a can with desiccant.

### SUMMARY OF THE INVENTION

The purpose of the invention is to further develop a test device of the type mentioned at the outset so that it has an improved shelf life.

This task is solved in a test device of the type mentioned above by providing at least one additional protective agent field on the surface of the substrate, which contains a desiccant and/or an oxygen absorber.

The invention is thus based on the idea of providing a protective agent field on the substrate of the test unit itself in addition to the test fields already present there. It has been shown that this measure can significantly extend the shelf life of the test units, as moisture-sensitive and/or oxygen-sensitive test fields or reaction fields are protected from contact with moisture or oxygen, which are absorbed by the desiccant or oxygen absorber. The additional protective agent field can thus significantly increase the storage stability of the test units.

According to one embodiment of the invention, at least one protective agent field is provided on the surface of the substrate, which comprises a desiccant and a further protective agent field is provided on the surface of the substrate, which comprises a oxygen absorber and/or at least one protective agent field comprising both a desiccant and an oxygen absorber is provided on the surface of the substrate. In other words, protective agent fields may be provided which comprise both a desiccant and an oxygen absorber. Likewise, protective agent fields may be provided which comprise only a desiccant or only an oxygen absorber. The respective selection depends on how much moisture is to be absorbed or how much oxygen is to be absorbed.

In a manner known per se, the substrate may be designed in the form of a rod. In this case, the at least one test field and/or the at least one protective agent field may be provided around the surface of the rod-shaped substrate.

Alternatively, the substrate may be strip-shaped, so that the test unit has the shape of a conventional test strip. In this case, the at least one test field is preferably provided on an upper side and/or on a lower side of the strip-shaped substrate, and the at least one protective agent field is provided on the upper side and/or on the lower side of the strip-shaped test field. In other words, the test fields can be provided on both the upper side and the lower side of the substrate. The same applies to the protective agent fields.

The protective agent fields can be of any size. If the test fields are of a uniform size, it has proven to be expedient for the protective agent field or fields to also be of a corresponding size. In principle, however, the size of the at least one protective agent field can be freely selected.

The same applies to the positioning of the test fields of the at least one protective agent field. One embodiment of the invention is characterized in that at least one test field, in particular all test fields, and at least one protective agent field, in particular all protective agent fields, are provided on the upper side of the strip-shaped substrate.

In a manner known per se, the desiccant may be a molecular sieve and/or silica gel or a polymer embedded desiccant.

In a further embodiment of the invention, it may be provided that the additional protective agent field is also applied during the production process of the test units, i.e., the attachment of the test fields to the substrate. Accordingly, a further embodiment of the test devices is characterized in that the protective agent field is applied to the substrate together with the at least one test field in a single operation.

According to one embodiment of the invention, each test unit is individually packaged, in particular sealed in aluminum or paper foil packaging.

Alternatively, the packaging may comprise a can, a bag, or a vial. In this case, several test units are packaged in the packaging, whereby, in particular, a desiccant reservoir is additionally provided in the packaging.

It is essential that, according to the invention, the test units are each housed in their respective packaging without the protective agent field being covered, for example by an adhesive strip, and thus protected against unwanted contact with moisture. Accordingly, the test unit is housed in the packaging with an exposed protective agent field or with exposed protective agent fields.

Preferably, the packaging can be a can closed with a stopper, and a desiccant, in particular a molecular sieve or silica gel, is housed in the stopper. A bag of desiccant can also be housed in the packaging. However, due to the protective agent fields provided on the substrates of the test units, additional desiccant in the packaging is not necessary.

In a manner known per se, several test fields may be provided on the substrate, each containing different reagents.

### BRIEF DESCRIPTION OF THE DRAWINGS

With regard to further embodiments of the invention, reference is made to the following embodiment of the invention with reference to the accompanying drawing. The drawing shows

FIG. 1 a test unit in the form of a test strip of a test unit according to the present invention in a front view.

### DETAILED DESCRIPTION OF THE PREFERRED EMBODIMENT(S)

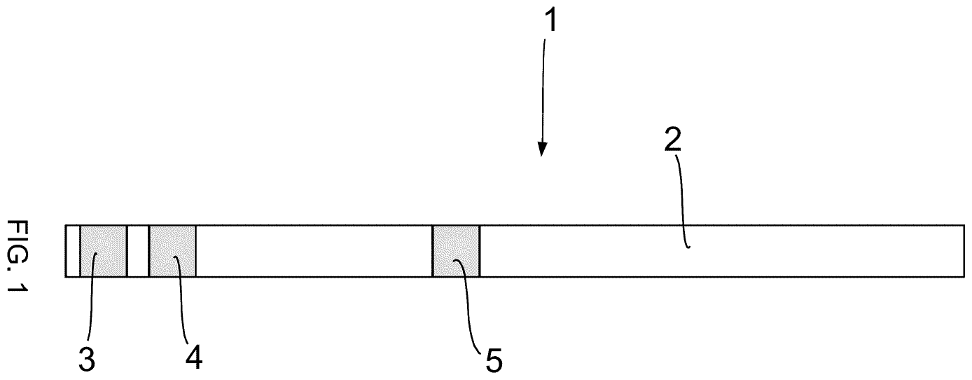

FIG. 1 shows a test strip that represents a test unit 1 of a test device according to the present invention. The test unit 1 comprises a substrate 2 that is designed in the form of a strip. Two test fields 3, 4 are provided on the upper side of the test strip, each of which contains different reagents and changes color when it comes into contact with a specified analyte.

The reagents in test fields 3 and 4 are moisture-sensitive. In order to protect them from unwanted contact with moisture and thus make them more durable, a protective agent field 5 is additionally provided on the upper side of substrate 1, which contains a desiccant such as a molecular sieve or silica gel. If protection against oxygen is also desired because some of the reagents are sensitive to oxygen, the protective agent field 5 may also contain an oxygen absorber or oxygen scavenger, or an additional protective agent field with an oxygen absorber may be provided on the substrate 1.

Not shown is that the test device comprises, in addition to the test unit 1, a packaging in which the test unit 1 can be stored. The packaging may, for example, be an aluminum or paper foil in which the test unit 1 is sealed. Alternatively, the packaging may comprise a can, a bag, or a vial in which several test units 1 are then packaged.

The protective agent field 5 can be applied to the substrate 2 during the production process of the test unit 1. This allows the protective agent field 5 to be combined with one or more parameters. The table below lists seven parameters that were stored with and without desiccant under stress conditions. For this purpose, test units/test strips with a corresponding test field with and without a protective agent field were produced and individually sealed in aluminum foil. For the nitrate parameter (entry 1), the test field was already discolored in the dry state after stress storage (without protective agent field), so that it was no longer possible to clearly identify it after immersion in test solutions. A similar result was observed for the nitrite and leukocyte parameters (entries 2 and 3). After stress storage, both test parameters showed a false color in the dry state and a false positive color reaction in a negative test solution. After storage, the blood test field also showed a false color and a weakened color reaction in the positive test solution (entry 4). Entries 5 and 6 show that density and pH test fields display an incorrect color in dry state and no clear assignment is possible after storage. The parameters nitrite, leukocytes, blood, density, and PH are frequently determined in urine analysis. Parameters glycol and copper exhibit color defects in dry state and no clear correlation to the value on the color scale if sealed without additional protective field (entries 7 and 8). The increased stability of individually sealed test strips due to the protective field provided increases user-friendliness and the reliability of the analysis results. All parameters were unremarkable both in the dry state and after immersion in test solutions when sealed with a protective field in accordance with the invention.

| | | Test strips without | Test strip with |
|---|---|---|---|
| Entry | Parameter | protective field | protective agent field |
| 1 | Nitrate | Incorrect color when dry; no | No false color when dry; |
| | | clear correlation to the value | correct assignment to the |
| | | on the color scale | value on the color scale |
| 2 | Nitrite | Color deviation in dry state; | No color change when dry; |
| | | false positive reaction | correctly assigned to the |
| | | | value on the color scale |
| 3 | Leukocytes | Incorrect color when dry; | No discoloration when dry; |
| | | false positive reaction | correct assignment to the |
| | | | value on the color scale |
| 4 | Blood | Incorrect color when dry; | No discoloration when dry; |
| | | weakened reaction | correct assignment to the |
| | | | value on the color scale |
| 5 | Density | Incorrect color when dry; no | No color deviation when dry; |
| | | clear assignment to the value | correct assignment to the |
| | | on the color scale | value on the color scale |
| 6 | pH | Color defect when dry; no | No color deviation when dry; |
| | | clear correlation to the value | correctly assigned to the |
| | | on the color scale | value on the color scale |
| 7 | Glycol | Color defect when dry; no | No color deviation when dry; |
| | | clear correlation to the value | correctly assigned to the |
| | | on the color scale | value on the color scale |
| 8 | Copper | Color defect when dry; no | No color deviation when dry; |
| | | clear assignment to the value | correctly assigned to the |
| | | on the color scale | value on the color scale |

We claim:

1. A test device comprising a test unit (1) with a substrate (2) and at least one test field provided on the surface of the substrate (2) and comprising at least one reagent, wherein at least one additional protective agent field (5) is provided on the surface of the substrate (2), which has a desiccant and/or an oxygen absorber.

2. The test device according to claim 1, wherein at least one protective agent field (5) is provided on the surface of the substrate (2), which comprises a desiccant, and a further protective agent field (5) is provided, which comprises an oxygen absorber, and/or that at least one protective agent field (5) is provided on the surface of the substrate (2), which comprises both a desiccant and an oxygen absorber.

3. The test device according to claim 1, wherein the substrate (2) is rod-shaped.

4. The test device according to claim 3, wherein the at least one test field (3, 4) and/or the at least one protective agent field (5) is provided circumferentially on the surface of the rod-shaped substrate (2).

5. The test device according to claim 1, wherein the substrate (2) is strip-shaped.

6. The test device according to claim 5, wherein at least one test field (3, 4) is provided on an upper side and/or a lower side of the strip-shaped substrate (2), and that at least one protective agent field (5) is provided on the upper side and/or on the lower side of the strip-shaped test field.

7. The test device according to claim 6, wherein at least one test field (3, 4) and at least one protective agent field (5) are provided on the upper side of the strip-shaped substrate (2).

8. The test device according to claim 1, wherein the desiccant is a molecular sieve and/or silica gel.

9. The test device according to claim 1, wherein the at least one protective agent field (5) is applied to the substrate (2) together with the at least one test field (3, 4) in a single operation.

10. The test device according to claim 1, further comprising packaging and the test unit (1) with exposed protective agent field (5) or with exposed protective agent fields (5) is accommodated in the packaging.

11. The test device according to claim 10, wherein the test unit (1) is housed individually in packaging, in particular sealed in aluminum or paper foil as packaging.

12. The test device according to claim 10, wherein the packaging comprises a can or a bag or a vial and several test units (1) are packaged in the packaging, wherein, in particular, a desiccant reservoir is additionally provided in the packaging.

13. The test device according to claim 12, wherein the packaging is a can closed with a stopper, and a desiccant, in particular a molecular sieve or silica gel, is accommodated in the stopper.

14. The test device according to claim 12, wherein a bag containing desiccant is accommodated in the packaging.

15. The test device according to claim 1, wherein several test fields are provided on the substrate (2), each of which has different reagents.

16. The test device according to claim 2, wherein the substrate (2) is rod-shaped.

17. The test device according to claim 2, wherein the substrate (2) is strip-shaped.

18. The test device according to claim 2, wherein the desiccant is a molecular sieve and/or silica gel.

19. The test device according to claim 3, wherein the desiccant is a molecular sieve and/or silica gel.

20. The test device according to claim 4, wherein the desiccant is a molecular sieve and/or silica gel.
